(19) United States
(12) Patent Application Publication
(10) Pub. No.: US 2014/0033523 A1
(43) Pub. Date: Feb. 6, 2014

(54) BRAZING METHOD

(71) Applicants: Kurt Allen Rakozy, Burnt Hills, NY (US); Jeffrey Michael Breznak, Waterford, NY (US); Andrew Batton Witney, Schenectady, NY (US)

(72) Inventors: Kurt Allen Rakozy, Burnt Hills, NY (US); Jeffrey Michael Breznak, Waterford, NY (US); Andrew Batton Witney, Schenectady, NY (US)

(73) Assignee: General Electric Company

(21) Appl. No.: 13/562,706

(22) Filed: Jul. 31, 2012

(51) Int. Cl. H01R 43/00

(52) U.S. Cl. 29/825

(57) ABSTRACT

A brazing method is provided including the steps of, preplacing a braze alloy on a first plurality of conductive strands, the first plurality of conductive strands comprising a first stator bar, preplacing a braze alloy on a second plurality of conductive strands, the second plurality of conductive strands comprising a second stator bar, and heating at least a portion of the first stator bar to join the first plurality of conductive strands and the second stator bar to join the second plurality of conductive strands. Another step is used for electrically connecting the first stator bar to the second stator bar.

### BACKGROUND OF THE INVENTION

The invention described herein relates generally to brazing. More specifically, the invention relates to a method of brazing.

Armature stator bars in large generators are usually formed of many individual strands interleaved in a predetermined pattern. The bars exit the stator and are retained by the end-winding support system. To form a coil, upper and lower stator bars are joined together in the end-winding region. Previous approaches have used multiple connector plates (or series straps) that connect both the upper and lower stator bars.

However, the end-winding region is a very crowded area and space is at a premium. In addition, multiple connector plates may impede flow of cooling gases or make routing of other elements more problematic. Connector plates may also suffer from vibration and their connection to the stator bars may become compromised over extended operating periods.

Thus, there is a need for an improved brazing method that improves joint quality of stator bars in the end-winding region while simplifying construction and increasing reliability.

### BRIEF DESCRIPTION OF THE INVENTION

In an aspect of the present invention, a brazing method is provided including the steps of, preplacing a braze alloy on a first plurality of conductive strands, the first plurality of conductive strands comprising a first stator bar, preplacing a braze alloy on a second plurality of conductive strands, the second plurality of conductive strands comprising a second stator bar, and heating at least a portion of the first stator bar to join the first plurality of conductive strands and the second stator bar to join the second plurality of conductive strands. Another step is used for electrically connecting the first stator bar to the second stator bar.

In another aspect of the present invention, a brazing method is provided including the steps of, preplacing a braze alloy on a first plurality of conductive strands, the first plurality of conductive strands comprising a first stator bar, preplacing a braze alloy on a second plurality of conductive strands, the second plurality of conductive strands comprising a second stator bar, heating at least a portion of the first stator bar to join the first plurality of conductive strands, and the second stator bar to join the second plurality of conductive strands, and electrically connecting the first stator bar to the second stator bar.

### BRIEF DESCRIPTION OF THE DRAWINGS

FIG. 1 illustrates a cross-sectional view of stator bars in a stator slot;

FIG. 2 illustrates a partial, cross-sectional illustration of the end winding region of stator 100;

FIG. 3 illustrates a brazing method, according to an aspect of the present invention; and

FIG. 4 illustrates a brazing method, according to an aspect of the present invention.

### DETAILED DESCRIPTION OF THE INVENTION

One or more specific aspects of the present invention will be described below. In an effort to provide a concise description of these aspects, all features of an actual implementation may not be described in the specification. It should be appreciated that in the development of any such actual implementation, as in any engineering or design project, numerous implementation-specific decisions must be made to achieve the developers' specific goals, such as compliance with machine-related, system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “one aspect” or “an embodiment” or “an aspect” of the present invention are not intended to be interpreted as excluding the existence of additional embodiments or aspects that also incorporate the recited features.

A dynamoelectric machine is defined as a machine that converts mechanical energy to electrical energy or vice-versa, including but not limited to generators and motors. However, it is to be understood that the present invention could also be applied to turbomachines as well, or any application where an improved brazing method is desired.

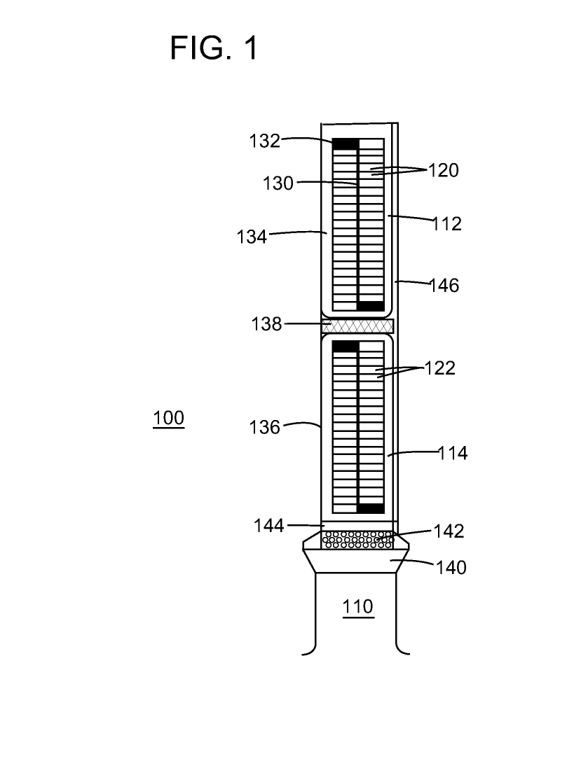

FIG. 1 illustrates a cross-sectional view of stator bars in a stator slot. A stator 100 includes a plurality of circumferentially arranged stator slots 110 (only one of which is shown in FIG. 1). The slot may contain a first stator bar 112 and a second stator bar 114. Each stator bar is comprised of a plurality of conductive strands 120. For example, the first stator bar 112 may include a first plurality of conductive strands 120, and a second stator bar may include a second plurality of conductive strands 122. Some stator mars may incorporate a vertical separator 130, filler between crossovers 132, an epoxy impregnated mica tape ground wall 134 and a glass tape armor layer 136. A filler element 138 may be interposed between the first stator bar 112 and the second stator bar 114. In addition, the slot may include one or more wedges 140, filler strips 142 and ripple springs 144. Side ripple springs 146 may also be placed between the stator bars and the sidewall of the stator slot 110. The side ripple springs are shown on the same side, but in some applications the side ripple springs may be arranged so that the “upper” (in relation to the drawing) side ripple spring is located on the right (as shown) and the “lower” side ripple spring is located on the left of the stator slot.

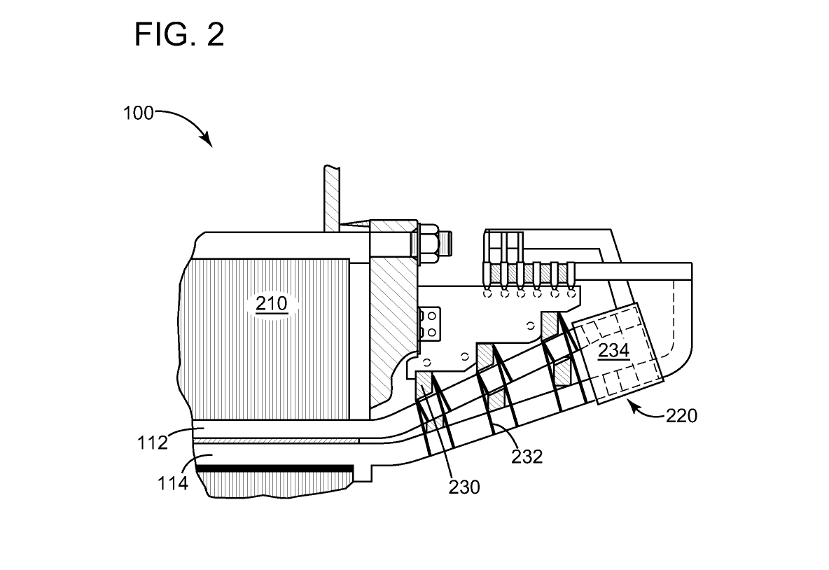

FIG. 2 illustrates a partial, cross-sectional illustration of the end winding region of stator 100. The stator bars 112, 114 exit the stator core and are electrically connected in end-winding region 220. As only one non-limiting example, the first and second stator bars may be joined together with binding bands 230 and ties 232. A connector plate 234 may be brazed to both stator bars, thereby forming an electrical connection. The connecting plate and stator bars may be comprised substantially of copper. The term “copper” may refer to copper or any predominantly copper-based alloy including, but not limited to, tough-pitch copper, oxygen-free copper, or silver-bearing copper (either tough-pitch or silver bearing).

It is important to have good quality connections in the region of the connector plate 234, and in some applications multiple connecting plates are used for each pair of stator bars. Unfortunately, this approach takes up a lot of valuable space in the end winding region. It would be beneficial if a higher quality connection could be used in the end winding region to simplify machine construction, reduce components, improve airflow and improve overall machine reliability.

In order to obtain high-quality brazed joints, the parts must be closely fitted, and the base metals must be exceptionally clean and free of oxides. In most cases, joint clearances of about 0.002 inches to about 0.008 inches are recommended for the best capillary action and joint strength. However, in some brazing operations it may be desirable to have joint clearances above or below this range. Cleanliness of the brazing surfaces and any preplaced braze alloy is also important, as any contamination can cause poor wetting (i.e., flow of the braze alloy), lack of adhesion to the parent metals, or unacceptable porosity in the resultant joint. The parts to be joined by brazing should be clean. Two methods for cleaning parts prior to brazing, are chemical cleaning, and abrasive or mechanical cleaning In the case of mechanical cleaning, it may be desirable to maintain a predetermined surface roughness as wetting on a rough surface occurs much more readily than on a smooth surface of the same geometry. The conductive strands 120, 122, in the region of the brazed joint, should be cleaned (or pre-cleaned) before brazing is initiated.

According to an aspect of the present invention, a method is provided for brazing the conductive strands in the end winding region of the stator bars. Insulation is removed on the stator bar in the region of the connecting plate attachment location. This will expose the individual conductive strands 120, 122. A braze alloy is preplaced on the first conductive strands 120. The braze alloy, in powder or particulate form, may be preplaced using cold spray deposition. However, preplacing may include deposition, mechanical placement, chemical placement or any other suitable method for preplacing the braze alloy. For mechanical placement methods, the braze alloy may be sheets, bands or strips of metal. However, a preferred method for preplacing the braze alloy is by cold spray deposition.

In cold spray deposition, the braze alloy plastically deforms the surface material on the conductive strands 122, 124. The copper material of the conductive strands is typically softer than the braze alloy. The plastic deformation of the conductive strands yields a superior surface for subsequent brazing by increasing the wettability of the brazed surfaces. The braze alloy may be comprised of an alloy from the BCuP family of braze alloys, in which the phosphorus present in the alloy functions as a flux, removing copper oxides during brazing and allowing a well-adhered joint to form without the need for a separately applied flux and/or a reducing atmosphere.

The BCuP braze alloy may be BCuP-5, which contains about 15% silver, 5% phosphorus, a balance of copper, and has a liquidus temperature of around 1,475° F. A brazing method using a combination of these types of braze alloys may also be referred to as a fluxless brazing method.

After the braze alloy is preplaced on the conductive strands, heating can be performed to braze the strands together. Brazing is generally defined as a joining process wherein coalescence is produced by heating to a suitable temperature above about 800° F. and by using a non-ferrous braze alloy, having a melting point below that of the materials to be joined. The heating step may be performed by induction heating, and the conductive strands 120, 122 may be heated to about 1,400° F. to about 1,550° F., or any other suitable temperature range as required by the specific material compositions. Other heating methods (e.g., torch heating, furnace, carbon arc, resistance, etc.) and other temperature ranges above or below those listed may also be used as desired in the specific application.

The previously described preplacing and heating steps may be repeated for the conductive strands of the second stator bar. This “first shot brazing” step brazes the individual conductive strands in each stator bar. A “second shot brazing” step connects (i.e., brazes) the connector plate 234 to both stator bars, thereby forming an electrical connection therebetween.

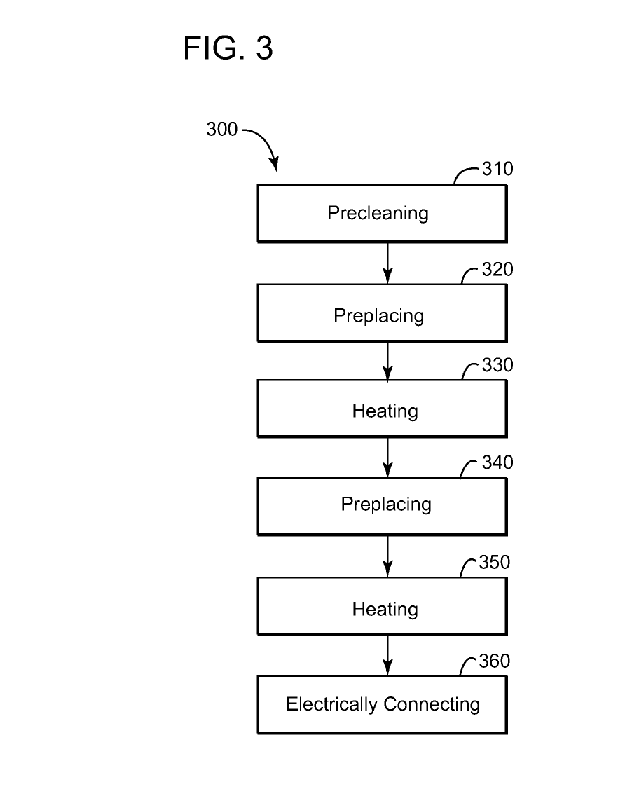

FIG. 3 illustrates a flow chart of a brazing method according to an aspect of the present invention. The brazing method 300 includes a step 310 of cleaning or precleaning the brazing region. For example, the first plurality of conductive strands and the second plurality of conductive strands may be cleaned prior to application of the braze alloy. The method 300 also includes a step 320 of preplacing a braze alloy on a first plurality of conductive strands. The first plurality of conductive strands may comprise a first stator bar. A step 330 of heating at least a portion of the first stator bar to join the first plurality of conductive strands, a step 340 of preplacing a braze alloy on a second plurality of conductive strands. The second plurality of conductive strands may comprise a second stator bar. The method also includes a step 350 of heating at least a portion of the second stator bar to join the second plurality of conductive strands, and a step 360 of electrically connecting the first stator bar to the second stator bar.

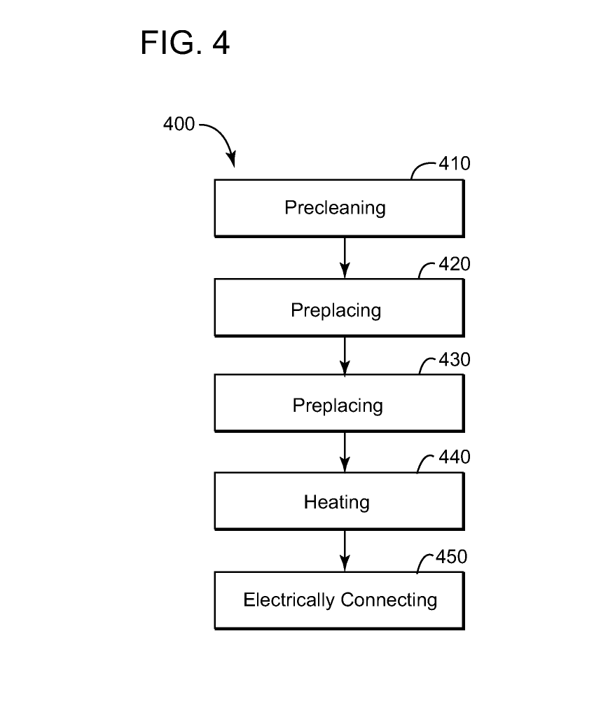

FIG. 4 illustrates a flow chart of a brazing method according to another aspect of the present invention. The brazing method 400 includes a step 410 of cleaning or precleaning the brazing region. For example, the first plurality of conductive strands and the second plurality of conductive strands may be cleaned prior to application of the braze alloy. The method 400 also includes a step 420 of preplacing a braze alloy on a first plurality of conductive strands, and a step 430 of preplacing a braze alloy on a second plurality of conductive strands. The first and second plurality of conductive strands may comprise first and second stator bars, respectively. A step 440 heats at least a portion of the first stator bar to join the first plurality of conductive strands, and heats at least a portion of the second stator bar to join the second plurality of conductive strands. Subsequently, step 450 electrically connects the first stator bar to the second stator bar.

The preplacing steps described above may be accomplished by using cold spray deposition. During the cold spray deposition preplacing steps, the braze alloy plastically deforms the surface material on the conductive strands. The conductive strands may be formed or comprised of copper. The heating steps may be performed by induction heating or torch heating. The braze alloy may be a BCuP alloy or any other suitable braze alloy material. The electrical connection step connects the first stator bar to the second stator bar by brazing a connector plate to both stator bars. All the methods described herein may also employ an inert gas purge atmosphere around the joint to be brazed, which may include the brazed region of the first and second plurality of conductive strands and the connector plate.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A brazing method comprising:
preplacing a braze alloy on a first plurality of conductive strands, the first plurality of conductive strands comprising a first stator bar;
heating at least a portion of the first stator bar to join the first plurality of conductive strands;
preplacing a braze alloy on a second plurality of conductive strands, the second plurality of conductive strands comprising a second stator bar;
heating at least a portion of the second stator bar to join the second plurality of conductive strands;
electrically connecting the first stator bar to the second stator bar.

2. The brazing method of claim 1, wherein both of the preplacing steps are performed by cold spray deposition.

3. The brazing method of claim 2, wherein during both of the preplacing steps deposition of the braze alloy plastically deforms surface material on the first plurality of conductive strands and surface material on the second plurality of conductive strands.

4. The brazing method of claim 3, further comprising the step of:
providing the first plurality of conductive strands and the second plurality of conductive strands comprised of copper.

5. The brazing method of claim 2, the electrically connecting step further comprising:
attaching at least one connector plate to the first stator bar and to the second stator bar.

6. The brazing method of claim 2, the electrically connecting step further comprising:
brazing the first stator bar to the second stator bar.

7. The brazing method of claim 1, wherein the braze alloy is a BCuP alloy.

8. The brazing method of claim 1, further comprising:
precleaning at least one of the first plurality of conductive strands and the second plurality of conductive strands.

9. The brazing method of claim 1, further comprising:
providing an inert gas purge around at least one of the first plurality of conductive strands and the second plurality of conductive strands.

10. The brazing method of claim 1, wherein the heating steps are performed by at least one of: induction heating and torch heating.

11. A brazing method comprising:
preplacing a braze alloy on a first plurality of conductive strands, the first plurality of conductive strands comprising a first stator bar;
preplacing a braze alloy on a second plurality of conductive strands, the second plurality of conductive strands comprising a second stator bar;
heating at least a portion of the first stator bar to join the first plurality of conductive strands, and the second stator bar to join the second plurality of conductive strands;
electrically connecting the first stator bar to the second stator bar.

12. The brazing method of claim 11, wherein both of the preplacing steps are performed by cold spray deposition.

13. The brazing method of claim 12, wherein during both of the preplacing steps cold spray deposition of the braze alloy plastically deforms surface material on the first plurality of conductive strands and surface material on the second plurality of conductive strands.

14. The brazing method of claim 13, further comprising the step of:
providing the first plurality of conductive strands and the second plurality of conductive strands comprised of copper.

15. The brazing method of claim 12, the electrically connecting step further comprising:
attaching at least one connector plate to the first stator bar and to the second stator bar.

16. The brazing method of claim 12, the electrically connecting step further comprising:
brazing the first stator bar to the second stator bar.

17. The brazing method of claim 11, wherein the braze alloy is a BCuP alloy.

18. The brazing method of claim 11, further comprising:
precleaning at least one of the first plurality of conductive strands and the second plurality of conductive strands.

19. The brazing method of claim 11, further comprising:
providing an inert gas purge around at least one of the first plurality of conductive strands and the second plurality of conductive strands.

20. The brazing method of claim 11, wherein the heating steps are performed by at least one of: induction heating and torch heating.
